(19) United States
(12) Patent Application Publication
(10) Pub. No.: US 2009/0235959 A1
(43) Pub. Date: Sep. 24, 2009

(54) Assembly and Device

(75) Inventors: Karl Ludwig Gibis, Limburgerhof (DE); Chris Efstathios Housmekerides, Ludwigshafen (DE)

Correspondence Address: NORRIS, MCLAUGHLIN & MARCUS, 875 THIRD AVE, 18TH FLOOR, NEW YORK, NY, 10022, US

(73) Assignee: RECKITT BENCKISER N.V., Hoofddorp (NL)

(21) Appl. No.: 12/092,612

(22) PCT Filed: Oct. 30, 2006
(86) PCT No.: PCT/GB06/04020

§ 371 Date: Aug. 18, 2008

(30) Foreign Application Priority Data
Nov. 7, 2005 (GB) 0522660.0

(51) Int. Cl. A47L 15/44; B08B 3/00; C11D 17/00

(52) U.S. Cl. 134/93; 510/224

(57) ABSTRACT

An assembly comprising a unit dose element (4) of soluble or dispersible composition useful in ware washing, and a chamber (2) therefor, the chamber having an inlet for water at a upper position of the chamber, and an outlet for water at a lower position of the chamber, the inlet comprising or being in communication with water directing means (34) whereby water is directed to the mid-region of the upper end of the unit dose element, the unit dose element being undersized relative to the interior of the chamber such that there is a gap between the or each exterior surface of the unit dose element and the opposed internal surface or surfaces of the chamber.

This invention relates to an assembly of:

(1) a unit dose element of soluble or dispersible composition using in ware washing, and (2) a chamber therefor;
and to a device comprising a plurality of such assemblies.

The primary interest is in the dishwashing field, but the laundry and water softener fields are also of interest. References made for ease of reference herein to the dishwashing field do not exclude these other fields.

Existing commercial dishwashing compositions are usually tablets formed by compression and consolidation of particulates. Such tablets are usually individually wrapped, in order to keep them in good condition. However it is an inconvenience for consumers, to have to unwrap a tablet for each wash.

We are seeking to offer a convenient multi-dose device for users of dishwasher machines. However, we have found it difficult to achieve reliable, complete wash-out (e.g. by dissolution or dispersal) of unit dose elements of detergent composition, from chambers in which they are contained.

After much work and thinking, involving attempting a number of proposed technical solutions which we expected to be good but which were, in fact, defective, we have found an excellent technical solution. The defective technical solutions as well as the excellent technical solution are set out in the examples, to provide as full an understanding as we can.

In accordance with a first aspect of the present invention there is provided an assembly comprising a unit dose element of soluble or dispersible composition useful in ware washing, and a chamber therefor, the chamber having an inlet for water at a upper position of the chamber, and an outlet for water at a lower position of the chamber, the inlet comprising or being in communication with water directing means whereby water is directed to the mid-region of the upper end of the unit dose element, the unit dose element being undersized relative to the interior of the chamber such that there is a gap between the or each exterior surface of the unit dose element and the opposed internal surface or surfaces of the chamber.

Preferably the water directing means is a funnel, whose outlet is located above the mid-region of the upper end.

Preferably a said gap is provided of width from 1 to 5 mm inclusive.

Preferably a said gap is provided of width from 2 to 4 mm inclusive.

Preferably a said gap extends fully around the exterior surface of the unit dose element, that is, preferably without any points of contact.

Suitably the width of the gap is not constant around the exterior surface of the unit dose element.

Preferably the assembly is designed such that, in use in a dishwasher, water transiently collects in the chamber.

Preferably the inlet is of area in the range 6-11 mm².

Preferably the outlet is of area in the range 18-25 mm².

Preferably the unit dose element does not have any through-bore(s).

Preferably the base of the unit dose element is raised from the base of the chamber.

Preferably the unit dose element and the chamber are both generally trigonal or frusto-trigonal.

Preferably the unit dose element is of a coherent mass of composition useful in ware washing. Preferably it comprises at least 20 wt % of methyl glycine diacetic acid and/or a salt thereof (also referred to herein collectively as MGDA) and/or of glutamic diacetic acid and/or a salt thereof (also referred to herein collectively as GDA).

In the present specification when we say that the composition is a substantially coherent mass, we mean that it has a solid or non-porous or non-particulate microstructure or is continuous. The composition may function as a matrix for other components, e.g. particulates, for example enzymes. The unit dose elements may, for example, be formed by injection moulding or by extrusion, but not by pressing of particulates.

Throughout this specification “wt %” denotes the weight of the named component as a percentage of the total weight of the composition, unless otherwise stated explicitly.

The percentage definitions given herein apply to MGDA and GDA in combination, when both are present.

The MGDA and/or GDA is/are present as a builder. A further builder, or builders, may be present.

A preferred MGDA and GDA compound is in each case the disodium salt.

An inorganic builder may be present as an additional builder in the present invention. Suitable inorganic builders may include carbonates, bicarbonates, borates, silicates, aluminosilicates, phosphates, such as STPP, and phosphonates.

When a further builder is present it is preferably an organic builder, or builders; preferably selected from water-soluble monomeric polycarboxylic acids and/or their acid forms, suitably as monomers or oligomers. Examples of suitable organic builders include the water-soluble salts of citric acid, tartaric acid, lactic acid, glycolic acid, succinic acid, malonic acid, maleic acid, diglycolic acid and fumaric acid. Other suitable organic builders are polyacrylates and co-polymers of acrylates with maleic acid and sulfonated polymers. Other suitable organic builders are polyasparaginic acid and its salts and iminodisuccinic acid and its salts.

A further builder (or builders) may suitably be present in an amount of at least 5 wt %, preferably at least 10 wt %, more preferably at least 15 wt % (total amounts, when there is more than one further builder present).

A further builder (or builders) may suitably be present in an amount of up to 50 wt %, preferably up to 30 wt %, more preferably up to 25 wt % (total amounts, when there is more than one further builder present).

Generally the detergent body formulation comprises a lubricant. Such a material has been found to display excellent properties in the formation of the unit dose elements. Namely a lubricant may facilitate the transport of the detergent composition into/within, for example, the injection moulding mould or to enable the extrusion process.

A lubricant is preferably present at an amount of from 0.1 wt % to 30 wt %, more preferably from 10 wt % to 20 wt %.

Most preferably the lubricant is polyethylene glycol having a nominal molecular weight of 1000 to 5000.

Preferably the compositions contain at least 0.1 wt % polyvinyl-pyrrolidone (PVP), preferably at least 0.2 wt %. Preferably up to 5 wt % PVP is present, more preferably up to 3 wt %, most preferably up to 1 wt %.

The compositions, particularly may also independently comprise enzymes, such as protease, lipase, amylase, cellulase and peroxidase enzymes. Such enzymes are commercially available and sold, for example, under the registered trade marks Esperase, Alcalase and Savinase by Nova Industries A/S and Maxatase by International Biosynthetics, Inc. Desirably the enzyme(s) is/are present in the composition in an amount of from 0.01 to 3 wt %, especially 0.01 to 2 wt % (total enzyme complement present). These amounts relate to the commercial preparations, which contain additional materials; the equivalent amount of pure enzyme present is probably about one-fifth of the as-supplied amount, in a typical case.

Preferably particulate components such as enzymes are enrobed or enveloped in the detergent composition.

The composition may contain surface active agents such as an anionic, non-ionic, cationic, amphoteric or zwitterionic surface active agents or mixtures thereof. Many such surfactants are described in Kirk Othmer's Encyclopedia of Chemical Technology, 3^{rd} Ed., Vol. 22, pp. 360-379, “Surfactants and Detersive Systems”, incorporated by reference herein.

A surfactant, or surfactants, may be present in the composition in an amount of at least 1 wt %, preferably at least 5 wt % (total complement). A surfactant, or surfactants, may be present in the composition in an amount of up to 30 wt %, preferably up to 20 wt %, more preferably up to 10 wt % (total complement).

When a surfactant is present a nonionic surfactant is preferred.

The detergent body may further include other common detergent components such as foam control agents, pH control or adjustment agents, corrosion inhibitors, surfactants, fragrances, anti-bacterial agents, preservatives, pigments and dyes.

Bleaches could also be included, optionally with bleach activators. When a bleach is present, it is preferably present in the composition in an amount of at least 1 wt %, more preferably at least 2 wt %, more preferably at least 4 wt %; and in an amount of up to 30 wt %, more preferably up to 20 wt %, and most preferably up to 15 wt %. It is preferably selected from inorganic perhydrates such as peroxymonopersulfate (KMPS) or organic peracids and the salts thereof; for example phthalimidoperhexanoic acid (PAP).

Sulfonated polymers may be suitable for use in the compositions used in the present invention. Preferred examples include copolymers of CH₂═CR¹—CR²R³—O—C₄H₃R⁴—SO₃X wherein R¹, R², R³, R⁴ are independently 1 to 6 carbon alkyl or hydrogen, and X is hydrogen or alkali with any suitable other monomer units including modified acrylic, fumaric, maleic, itaconic, aconitic, mesaconic, citraconic and methylenemalonic acid or their salts, maleic anhydride, acrylamide, alkylene, vinylmethyl ether, styrene and any mixtures thereof. Other suitable sulfonated monomers for incorporation in Sulfonated (co)polymers are 2-acrylamido-2-methyl-1-propanesulfonic acid, 2-methacrylamido-2-methyl-1-propanesulfonic acid, 3-methacrylamido-2-hydroxy-propanesulfonic acid, allysulfonic acid, methallysulfonic acid, 2-hydroxy-3-(2-propenyloxy)propanesulfonic acid, 2-methyl-2-propenen-1-sulfonic acid, styrenesulfonic acid, vinylsulfonic acid, 3-sulfopropyl acrylate, 3-sulfopropylmethacrylate, sulfomethylacrylamide, sulfomethylmethacrylamide and water soluble salts thereof.

When a sulfonated polymer is present, it is preferably present in the composition in an amount of at least 0.1 wt %, preferably at least 0.5 wt %, more preferably at least 1 wt %, and most preferably at least 3 wt %.

When a sulfonated polymer is present, it is preferably present in the composition in an amount of up to 40 wt %, preferably up to 25 wt %, more preferably up to 15 wt %, and most preferably up to 10 wt %.

Sulfonated polymers are used in detergency applications as polymers to disperse Ca-phosphate compounds and prevent their deposition. To our surprise we have found them to give cleaning benefits in combination even with preferred phosphorus-free compositions of the present invention.

The compositions used in the present invention are very well adapted to manufacture by the forming process which involve elevating the temperature of the composition, then forming it to a shape when liquefied, or softened. Examples include injection moulding (e.g. in accordance with the process described in WO 2005/035709), pour-moulding or casting, and extrusion. In such processes the temperature of the composition may be in the range 30 to 60° C., preferably 40 to 50° C. It is found that the composition is not degraded to any substantive level, not even when enzymes are present; enzymes being, of course, heat sensitive. It may be that the coherent form (e.g. matrix) of the composition affords protection to the enzymes.

The unit dose elements used in the present invention are preferably self-supporting. For example they may be in the form of a lozenge or stick or ball.

Preferably the unit dose elements of the present invention are insoluble or not very soluble in the cold water of a prewash but easily soluble in the hot water of a main wash. By not very soluble, we mean that not more than 10% of the weight of the unit dose element dissolves in the prewash.

The unit dose elements may be coated with an agent which screens the detergent from the atmosphere. However this may not be needed. To our surprise we have found that unit dose elements of detergent composition in accordance with the present invention appear to be resistant to atmospheric degradation for a useful period, even when a plurality of unit dose elements are contained within a refill, and the respective unit dose elements are dissolved one at a time, in a generally humid environment. Even the last unit dose element to be dissolved has remained in good condition, in our experiments.

In accordance with a second aspect of the present invention there is provided a refill device comprising a plurality of assemblies as defined above, provided in an array for sequential dissolution or dispersal in a ware washing machine, one in each wash.

Preferably the array is arranged in a ring and the sequential dissolution or dispersal is by stepwise rotary movement of the refill device or of a part which cooperates with it.

Preferably each unit dose element and each chamber is generally wedge-shaped or generally trigonal or frusto-trigonal, and wherein the chambers are arranged together to form segments of the refill device.

In accordance with a third aspect of the present invention there is provided a method of providing a refill device as described above, the method comprising the formation of the unit dose elements without using a tablet compaction method.

The invention will now be further described, by way of example, with reference to the accompanying drawings, in which:

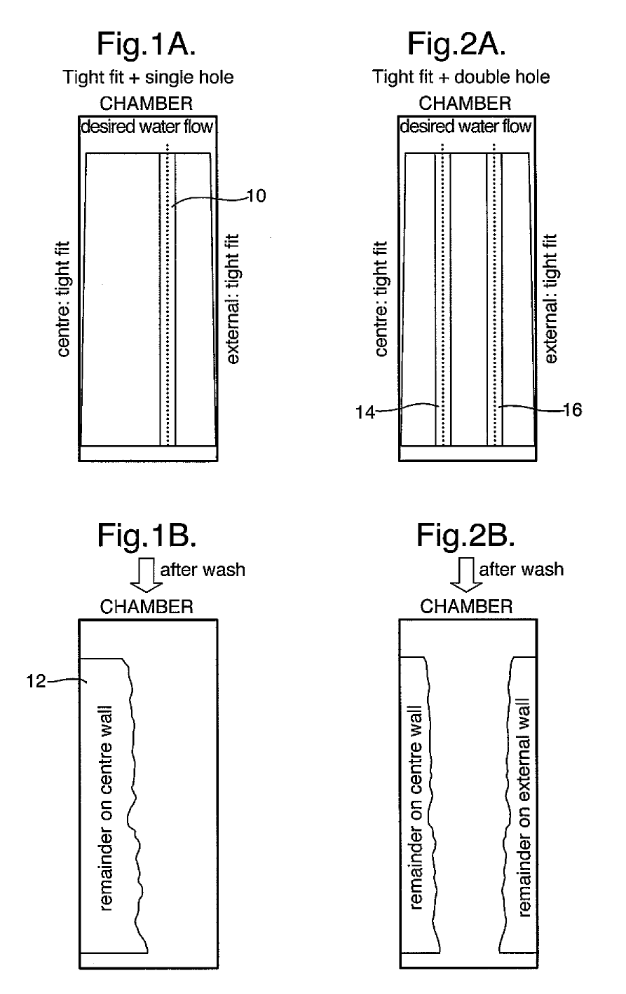

FIGS. 1A and 1B are schematic central vertical cross-sectional views of a first comparative embodiment of unit dose element/chamber assembly, before and after wash-out.

FIGS. 2A and 2B are schematic central vertical cross-sectional views of a second comparative embodiment of unit dose element/chamber assembly, before and after wash-out.

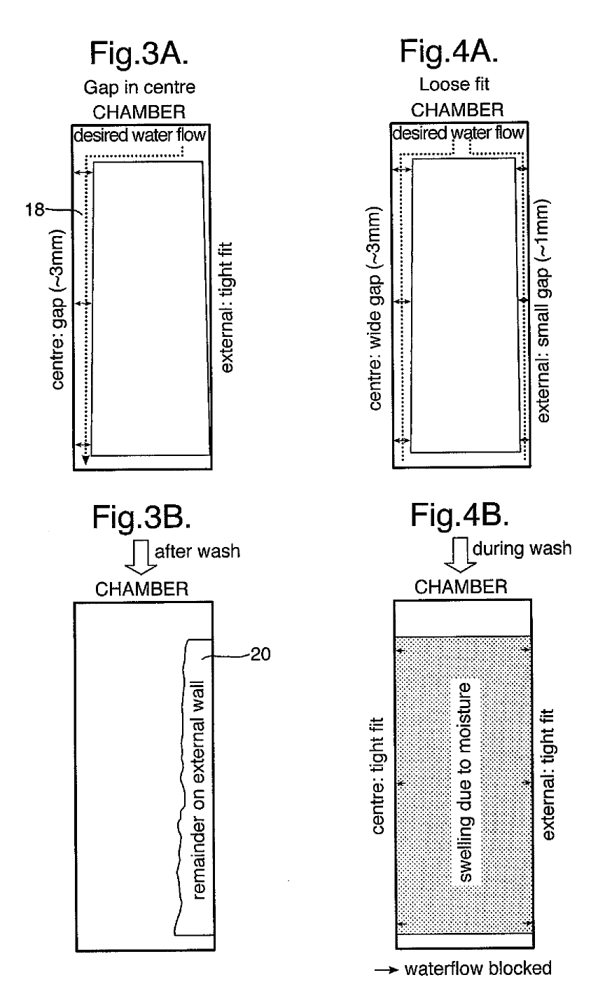

FIGS. 3A and 3B are schematic central vertical cross-sectional views of a third comparative embodiment of unit dose element/chamber assembly, before and after wash-out.

FIGS. 4A and 4B are schematic central vertical cross-sectional views of a fourth comparative embodiment of unit dose element/chamber assembly, before and after wash-out.

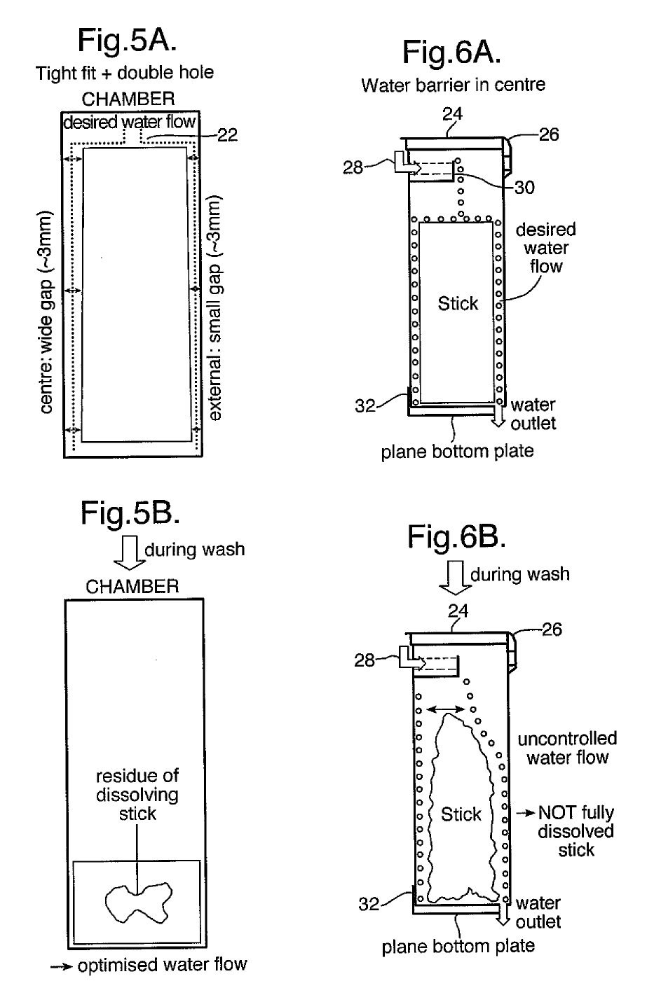

FIGS. 5A and 5B are schematic central vertical cross-sectional views of a first embodiment of unit dose element/chamber assembly in accordance with the invention, before and after wash-out.

FIGS. 6A and 6B are schematic vertical cross-sectional view of a fifth comparative embodiment, showing water inlet and outlets of the chamber.

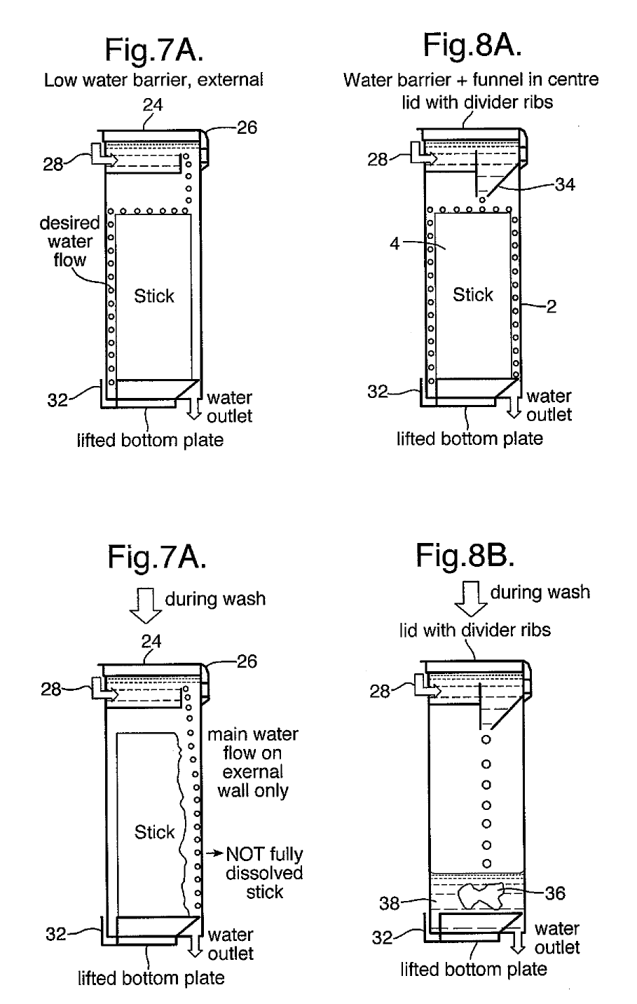

FIGS. 7A and 7B are schematic vertical cross-sectional view of a sixth comparative embodiment, showing water inlet and outlets of the chamber.

FIGS. 8A and 8B are schematic central vertical cross-sectional views of a second inventive embodiment of unit dose element/chamber assembly in accordance with the invention, before and after wash-out.

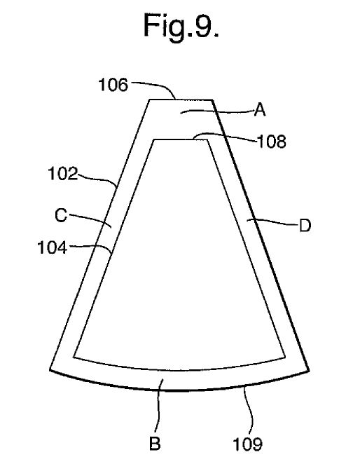

FIG. 9 is a plan view of the assemblies shown in FIGS. 8A and 8B.

In FIGS. 1A, 2A, to 8A, the expected water flow pathway(s) is/are shown in dotted lines.

In each of the examples the chamber 2 and unit dose element 4 are wedge-shaped or trigonal in cross-section, as shown in FIG. 9. They are truncated, however, at the apex or central end 6, 8, leaving a substantial inner space, about 20 mm² in area. Each has an arcuate outside surface 9. However the position of the element 4 within the chamber 2 differs in different embodiments, as will be described.

In each of the examples the composition was the following injection moulding composition suitable for ADW use.

TABLE 1

| | Amount |
|---|---|
| raw materials | % (t.q.) |
| PEG 1500 | 5.00 |
| MGDA disodium salt/PEG 15004:1 blend (wt:wt) | 67.45 |
| Sodium carbonate | 7.85 |
| NI surfactant C16-18/25 EO fatty alcohol (Lutensol AT25, | 2.00 |
| BASF) | |
| NI surfactant C16-18/3EO-PO fatty alcohol, low foaming | 1.90 |
| (Plurafac LF500, BASF) | |
| Dehypon 3697 GRA M (Cognis) | 1.50 |
| Polyacrylate(Norasol LMW 45) | 5.00 |
| Enzymes (protease) | 1.50 |
| Enzymes (amylase) | 0.50 |
| Binder, polyvinyl-pyrrolidone (PVP) | 2.00 |
| Defoamer liquid (Silicon SE 36, Wacker) | 0.20 |
| Fragrance | 0.10 |
| Total | 100.00 |

Although the figures show single generally trigonal chambers they are in fact part of a rotary refill device which is segmented, each chamber of the device constituting one of the segments.

Each unit dose element 4 is a somewhat elongate body, formed by injection moulding. The composition is as described above. The unit dose elements of FIGS. 1-5 taper slightly in the upwards direction. The chambers also taper slightly in the upwards direction, to match.

Throughput of water in ADW trials in each case was 200 ml/minute. The machine used was a Miele 651 SC, at the setting called “Normal 50° C.”.

In FIG. 1A the unit dose element (“hereinafter “stick”) fits tightly into the chamber at its wider, lower end, and has a slightly off-centre through-bore 10 generally cylindrical but tapering, of diameter 3.8 mm at the top of the stick and 5.6 mm at the bottom of the stick. The through-bore intended to be driver of the dissolution of the stick. However it was found that composition remained in the chamber, adhered to the inside wall at 12, the wall further from the through-bore (FIG. 1B).

In FIG. 2A the approach taken was to provide the stick with a second through-bore. Both trough-bores were identical to that of FIG. 1A. However it was then found that composition remained in the chamber, adhered (at 14, 16) to both the inside wall and the outside wall.

To our surprise, through-bores did not provide a way forward.

In FIG. 3A a slightly narrower stick was provided, still slightly tapering but with no through-bore(s), and with a 3 mm gap 18 down the inside wall, at the apex of the wedge, and tight on the outside wall, at the lower end of the stick.

However, in use, a residue 20 was left on that opposite wall (FIG. 3B).

In FIG. 4A the stick is shown with a 3 mm gap down one side, at the apex of the wedge, and a 1 mm gap at the outside wall. However very poor dissolution was obtained; the stick swelled and effectively blocked the chamber, preventing through-flow of water (FIG. 4B).

In FIG. 5A, exemplifying the present invention, a 3 mm gap A was left down the inside wall, at the apex of the wedge, and down the opposite, outside wall (see FIG. 9). Provided water was delivered to the central region 22 of the top wall of the stick full dissolution was reliably achieved. It was observed that allowing some water to be collected in the chamber was of benefit in soaking then dissolving or dispersing any remaining small pieces of the composition (FIG. 5B). In this embodiment the gap B at the outside wall of the chamber is 1 mm and the gaps C, D at the side walls is 1 mm.

FIGS. 6A and 6B show a further comparative embodiment with further detail of the chamber. The chamber has a plane lid 24 and gasket 26, and a water inlet 28 in the upper side wall of the chamber. The inlet leads to a small reservoir 30 which feeds water to the stick once a certain head of water has been reached. The intention was that water would be fed to the mid-region of the upper face of the stick. The stick sits directly on the bottom of the chamber. In this embodiment (as in the other embodiments) the stick and chamber tapers in the upwards direction and a gap of 3 mm is provided at the inside wall at the apex of the “wedge” the gap elsewhere being 1 mm.

We expected the water to flow as shown in FIG. 6A, so achieving dissolution as shown in FIG. 5, but in fact the stick was only dissolved by a minor amount (FIG. 6B).

FIG. 7 are similar to FIG. 6 but water delivery was intended to be to the inside wall region of the assembly, not to the mid-region. Also, the stick was raised from the bottom of the chamber by a lift plate 32. We found that only the outside region of the stick was dissolved (FIG. 7B).

We believe the failures of FIGS. 6 and 7 embodiments may be due to surface tension effect; the in effect under the influence of surface tension at this relatively water flow rate, water follows its own path.

FIG. 8 also have the variation from the embodiment of FIG. 6, that a lift plate is provided; but an additional variation is the design of the top of the chamber. The water inlet leads to a funnel 34. The funnel delivers water assuredly to the mid-region of the top face of the stick. It is found that complete dissolution occurs reliably. The dissolution of small residues such as 36 is aided by the fact that some water collects transiently in the chamber, as shown at 38. To facilitate this the area of the outlet is 20-25 mm² and the area of the inlet is 8-11 mm².

1. An assembly comprising a unit dose element of soluble or dispersible composition useful in ware washing, and a chamber therefor, the chamber having an inlet for water at a upper position of the chamber, and an outlet for water at a lower position of the chamber, the inlet comprising or being in communication with water directing means whereby water is directed to the mid-region of the upper end of the unit dose element, the unit dose element being undersized relative to the interior of the chamber such that there is a gap between the or each exterior surface of the unit dose element and the opposed internal surface or surfaces of the chamber.

2. An assembly as claimed in claim 1, wherein the water directing means is a funnel, whose outlet is located above the mid-region of the upper end.

3. An assembly according to claim 1, wherein a said gap is provided of width from 1 to 5 mm inclusive.

4. An assembly according to claim 3, wherein a said gap is provided of width from 2 to 4 mm inclusive.

5. An assembly according to claim 1, wherein the gap extends fully around the exterior surface of the unit dose element.

6. An assembly according to claim 5, wherein the width of the gap is not constant around the exterior surface of the unit dose element.

7. An assembly according to claim 1, wherein volume of the chamber is from 6 to 40% greater than the volume of a unit dose element.

8. An assembly according to claim 1 wherein, in use in a dishwasher, water transiently collects in the chamber.

9. An assembly according to claim 1 wherein the inlet is of area in the range 6-11 mm².

10. An assembly according to claim 1, wherein the outlet is of area in the range 18-25 mm².

11. An assembly according to claim 1, wherein the unit dose element is of a coherent mass of detergent composition.

12. An assembly according to claim 11, wherein the unit dose element is made by injection moulding, extrusion or casting.

13. An assembly according to claim 1, wherein the unit dose element does not have any through-bore(s).

14. An assembly according to claim 1, wherein the base of the unit dose element is raised from the base of the chamber.

15. An assembly according to claim 1, wherein the unit dose element and the chamber are both generally trigonal or frusto-trigonal.

16. A refill device comprising a plurality of assemblies according to claim 1, provided in an array for sequential dissolution or dispersal in a ware washing machine, one in each wash.

17. A refill device according to claim 16, wherein the array is arranged in a ring and the sequential dissolution or dispersal is by stepwise rotary movement of the refill device or of a part which cooperates with it.

18. A refill device according to claim 16, wherein each unit dose element and each chamber are generally trigonal or frusto-trigonal, and wherein the chambers are arranged together to form segments of the refill device.

19. A method of providing a refill device according to claim 16, the method comprising the formation of the unit dose elements without using a tablet compaction method.
